(19) United States
(12) Patent Application Publication
(10) Pub. No.: US 2021/0409613 A1
(43) Pub. Date: Dec. 30, 2021

(54) INFORMATION PROCESSING DEVICE, INFORMATION PROCESSING METHOD, PROGRAM, AND INFORMATION PROCESSING SYSTEM

(71) Applicant: SONY GROUP CORPORATION, Tokyo (JP)

(72) Inventor: Shinnosuke USAMI, Tokyo (JP)

(73) Assignee: Sony Group Corporation, Tokyo (JP)

(21) Appl. No.: 17/294,798

(22) PCT Filed: Dec. 6, 2019
(86) PCT No.: PCT/JP2019/047780

§ 371 Date: May 18, 2021

(30) Foreign Application Priority Data
Dec. 21, 2018 (JP) 2018-239330

(51) Int. Cl. H04N 5/268; H04N 5/247; H04N 5/232; H04N 13/111; H04N 13/161; H04N 13/282

(52) U.S. Cl. CPC H04N 5/268; H04N 5/247; H04N 5/23216; H04N 13/282; H04N 13/111; H04N 13/161; H04N 5/23229

(57) ABSTRACT

The present technology relates to an information processing device, an information processing method, a program, and an information processing system that enables easy generation of a bullet-time video.

The information processing device includes a user selection unit that receives, on the basis of a related image related to a captured image obtained by any of a plurality of imaging devices, selection by a user with respect to a space direction indicating arrangement of the plurality of imaging devices and a time direction indicating imaging time of the captured image, and a control unit that requests a captured image from a processing device retaining a captured image corresponding to the selection by the user. The present technology can be applied to, for example, an information processing device, or the like, that generates a bullet-time video.

### TECHNICAL FIELD

The present technology relates to an information processing device, an information processing method, a program, and an information processing system, in particular to an information processing device, an information processing method, a program, and an information processing system that enables easy generation of a bullet-time video.

### BACKGROUND ART

A shooting technique called bullet-time shooting is known. In a bullet-time shooting, for example, images of a subject is shot by a plurality of cameras in synchronization, the images shot by the respective cameras are sent to an editorial apparatus, and a series of images (moving images) of which shooting directions are sequentially switched is generated in the editorial apparatus.

Although generation of a bullet-time video requires images of a subject shot from a plurality of directions, in Patent Document 1 for example, there is proposed an image processing device that generates, for example, a free-viewpoint image for which an arbitrary position, direction, or moving speed is freely set.

### CITATION LIST

### Patent Document

### Patent Document 1: Japanese Patent Application Laid-Open No. 2018-46448

### SUMMARY OF THE INVENTION

### Problems to be Solved by the Invention

Conventionally, in order to generate a bullet-time video, it has been necessary to send all the images shot by the plurality of cameras to an editorial apparatus.

The present technology has been developed to solve the problem mentioned above and to enable easy generation of the bullet-time video.

### Solutions to Problems

The information processing device according to a first aspect of the present technology includes a user selection unit that receives, on the basis of a related image related to a captured image obtained by any of a plurality of imaging devices, selection by a user with respect to a space direction indicating arrangement of the plurality of imaging devices and a time direction indicating imaging time of the captured image, and a control unit that requests a captured image from a processing device retaining a captured image corresponding to the selection by the user.

An information processing method and program according to a first aspect of the present technology is an information processing method and program corresponding to an information processing device according to the first aspect.

In the first aspect of the present technology, on the basis of a related image related to a captured image obtained by any of a plurality of imaging devices, selection by a user with respect to a space direction indicating arrangement of the plurality of imaging devices and a time direction indicating imaging time of a captured image is received, and a captured image is requested from a processing device retaining a captured image corresponding to the selection by the user.

The information processing device according to the first aspect of the present technology can be implemented by causing a computer to execute a program. The program can be provided by being transmitted via a transmission medium or by being recorded on a recording medium.

An information processing system according to a second aspect of the present technology includes a plurality of first information processing devices provided corresponding to a plurality of imaging devices, and a second information processing device, in which any one first information processing device among the plurality of first information processing devices sends, to the second information processing device, a related image related to a captured image obtained in corresponding the imaging device, and the second information processing device includes a user selection unit that receives, on the basis of the related image, selection by a user with respect to a space direction indicating arrangement of the plurality of imaging devices and a time direction indicating imaging time of the captured image, and a control unit that requests a captured image from the first information processing device retaining a captured image corresponding to the selection by the user.

In the second aspect of the present technology, a plurality of first information processing devices provided corresponding to a plurality of imaging devices, and a second information processing device are included, in which, in any one first information processing device among the plurality of first information processing devices, a related image related to a captured image obtained in corresponding the imaging device is sent to the second information processing device, and, in the second information processing device, on the basis of the related image, selection by a user with respect to a space direction indicating arrangement of the plurality of imaging devices and a time direction indicating imaging time of the captured image is received, and a captured image from the first information processing device is requested, the first information processing device retaining a captured image corresponding to the selection by the user.

The information processing device and the information processing system may be an independent device or may be an inner block including one device.

### BRIEF DESCRIPTION OF DRAWINGS

FIG. 1 is a diagram illustrating a configuration example of a shooting system to which the present technology is applied.

FIG. 2 is a diagram describing an overview of processing executed in the shooting system.

FIG. 3 is a block diagram illustrating a configuration example of a camera and a control device.

FIG. 4 is a block diagram illustrating a configuration example of hardware of a computer as an integrated editorial apparatus.

FIG. 5 is a diagram illustrating a screen example of a bullet-time edit screen.

FIG. 6 is a diagram describing a freely specified frame selection mode.

FIG. 7 is a diagram describing a series of flow of bullet-time video generation.

FIG. 8 is a flowchart describing processing of bullet-time video generation by the shooting system.

FIG. 9 is a diagram describing live view images subjected to thinning-out processing.

FIG. 10 is a diagram describing a user I/F in a case where a plurality of cameras is arranged in two dimensions.

FIG. 11 is a block diagram illustrating a configuration example of a camera in which functions of a camera and control device are integrated.

### MODE FOR CARRYING OUT THE INVENTION

A mode for carrying out the present technology (hereinafter, referred to as an embodiment) will be described below. Note that the description will be made in the following order.

1. Configuration example of shooting system

2. Overview of shooting system

3. Block diagram

4. Screen example

5. A series of flow of bullet-time video generation

6. Modifications

### 1. CONFIGURATION EXAMPLE OF SHOOTING SYSTEM

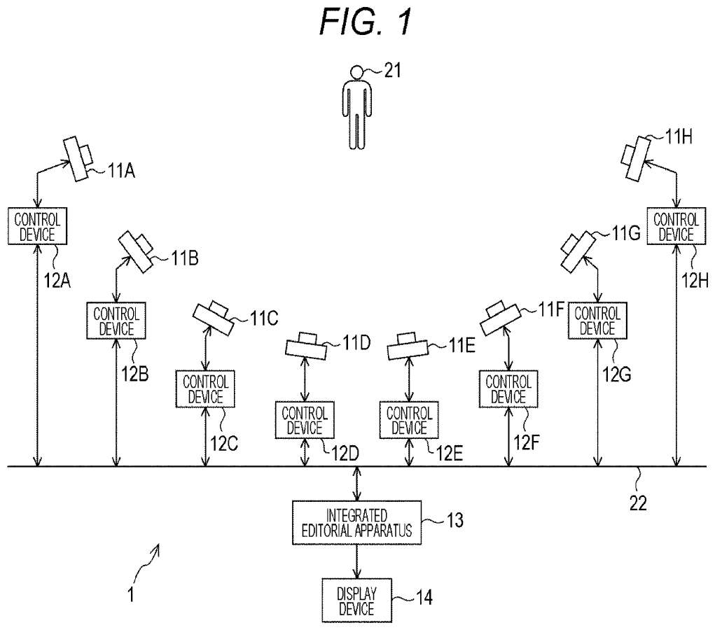

FIG. 1 illustrates a configuration example of a shooting system to which the present technology is applied.

The shooting system 1 in FIG. 1 is a system suitable for shooting and generation of the bullet-time video that is a series of images (a moving image) of which shooting directions are sequentially switched, and is configured including eight cameras 11A to 11H, eight control devices 12A to 12H, an integrated editorial apparatus 13, and a display device 14.

Note that, in the following description, the cameras 11A to 11H will also be simply referred to as a camera 11 in a case where the cameras are not particularly necessary to be distinguished from one another. Furthermore, the control devices 12A to 12H will also be simply referred to as a control device 12 in a case where the control devices are not particularly necessary to be distinguished from one another. In the shooting system 1, a camera 11 and a control device 12 are configured in pairs. Although an example in which the shooting system 1 includes eight cameras 11 and eight control devices 12 will be described in the example in FIG. 1, the number of cameras 11 and control devices 12 is not limited to eight, and the shooting system 1 may include any number of cameras 11 and control devices 12 scalably.

The cameras 11 capture images of a subject 21 according to control by the control devices 12, and provide the captured images (a moving image) obtained as a result to the control device 12. The camera 11 and the control device 12 are connected by a predetermined communication cable. As illustrated in FIG. 1, for example, a plurality (eight) of cameras 11 is arranged in an arc shape around the subject 21 and captures images in synchronization. Mutual positional relations among the plurality of cameras 11 are assumed to be known by being subject to calibration processing.

The control device 12 is connected to a camera 11 to be controlled, outputs an imaging instruction to the camera 11, and acquires and buffers (temporarily saves) one or more captured images that constitute a moving image provided from the camera 11. In response to a request from the integrated editorial apparatus 13 via a predetermined network 22, the control device 12 sends one or more captured images to the integrated editorial apparatus 13 or sends a related image related to the captured image to the integrated editorial apparatus 13.

Here, the related image is an image obtained by performing predetermined image processing, such as resolution conversion, frame rate conversion (frame thinning), or compression processing, on the buffered captured image. The related image is utilized, for example, for an image check during video shooting (live view image described later) or for an image check during captured image selection (stop image described later). Therefore, the control device 12 executes image processing, such as resolution conversion or compression processing, on the buffered captured image as necessary. Hereinafter, a captured image obtained from the camera 11 will be referred to as a frame image to be distinguished from the related image.

The network 22 may be, for example, various kinds of local area networks (LANs) or wide area networks (WANs) including, for example, the Internet, a telephone network, a satellite communication network, or Ethernet (registered trademark). In addition, the network 22 may be a dedicated line network such as an Internet Protocol-Virtual Private Network (IP-VPN). Furthermore, the network 22 is not limited to a wired communication network, and may be a wireless communication network.

The integrated editorial apparatus 13 is an operation terminal operated by a user who generates the bullet-time video, and includes, for example, a personal computer, a smartphone, or the like. The integrated editorial apparatus 13 executes an application program that shoots and edits the bullet-time video (hereinafter, referred to as a bullet-time video generation application as appropriate). On the bullet-time video generation application, the integrated editorial apparatus 13 receives operation by the user, and shoots and edits the bullet-time video on the basis of an instruction from the user. For example, the integrated editorial apparatus 13 instructs each of the control devices 12 to start or stop imaging of the subject 21. Furthermore, the integrated editorial apparatus 13 requests frame images necessary for the bullet-time video from the control devices 12, acquires the frame images, and generates the bullet-time video by using the acquired frame images.

The display device 14 is a display device such as a liquid crystal display (LCD) or an organic electro-luminescence (EL) display, which displays a screen of the bullet-time video generation application or a frame image of the subject 21, the frame image being acquired from the control device 12. Note that, for example, in a case where the integrated editorial apparatus 13 is integrated with a display such as a smartphone or a portable personal computer, the display device 14 is configured as a part of the integrated editorial apparatus 13.

### 2. OVERVIEW OF SHOOTING SYSTEM

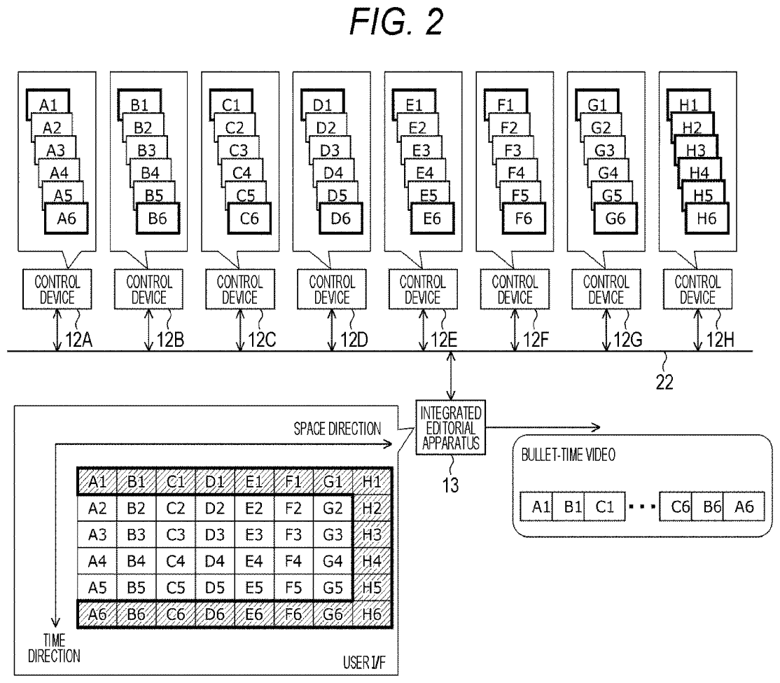

Next, an overview of processing executed by the shooting system 1 will be described with reference to FIG. 2.

On the basis of a command from the control device 12 based on operation by the user, the respective cameras 11 capture an image of the subject 21 at a timing in synchronization with the other cameras 11, provide the respective control devices 12 a frame image (a moving image) obtained as a result. The frame images captured by the respective cameras 11 include images of the same subject 21.

Each of the control devices 12 buffers the frame image provided from the corresponding camera 11. Here, it is assumed that six frame images have been captured in time series in each of the cameras 11 and buffered in each of the corresponding control devices 12.

Specifically, as illustrated in FIG. 2, six frame images A1 to A6 captured by the camera 11A are buffered in the control device 12A. Six frame images B1 to B6 captured by the camera 11B are buffered in the control device 12B. Hereinafter, similarly, six frame images G1 to G6 captured by the camera 11G are buffered in the control device 12G, and six frame images H1 to H6 captured by the camera 11H are buffered in the control device 12H.

As illustrated in FIG. 2, the integrated editorial apparatus 13 manages the frame images in an expression form in which the frame images buffered in each of the control devices 12 are arranged in a two-dimensional space. In the two-dimensional space, a horizontal axis (X-axis) represents a space direction (arrangement direction of the cameras 11) in accordance with arrangement of the cameras 11, and a vertical axis (Y-axis) represents a time direction in accordance with imaging times of the frame images, and the integrated editorial apparatus 13 uses a user interface (user I/F) that causes a user to select frame images necessary for the bullet-time video. Such a user I/F allows time relations and positional relations (relations between imaging directions of a subject) among the captured frame images to be easy to intuitively recognize, and allows the user to select necessary frame images easily.

For example, assuming that the frame images A1, B1, C1, D1, E1, F1, G1, H1 to H6, G6, F6, E6, D6, C6, B6, and A6, which are hatched and surrounded by a thick frame, are selected on the user I/F in the integrated editorial apparatus 13 in FIG. 2, only the selected frame images are provided from the control devices 12 to the integrated editorial apparatus 13 via the network 22.

The integrated editorial apparatus 13 generates the bullet-time video by encoding the acquired frame images in a predetermined order. A frame rate of the bullet-time video is determined in advance by an initial setting or at a time of video generation. An order of the frame images when encoding the selected frame images can also be determined in advance with an initial setting and can be determined also at a time of video generation.

In this way, in the integrated editorial apparatus 13, only frame images necessary for generation of the bullet-time video are acquired from each of the control devices 12, and frame images not used for generation of the bullet-time video are not downloaded, by which a network bandwidth used for acquisition of the frame images can be reduced, and a memory area of the integrated editorial apparatus 13 to be used can be reduced.

Note that, in a case where the arrangement of each of the cameras 11 is not in a line as illustrated in FIG. 1 but in a substantially circular shape centered at the subject 21, the frame images can be managed in a two-dimensional space with the space direction and the time direction, regarding the arrangement as an arrangement in a line originating from a predetermined one camera 11.

### 3. BLOCK DIAGRAM

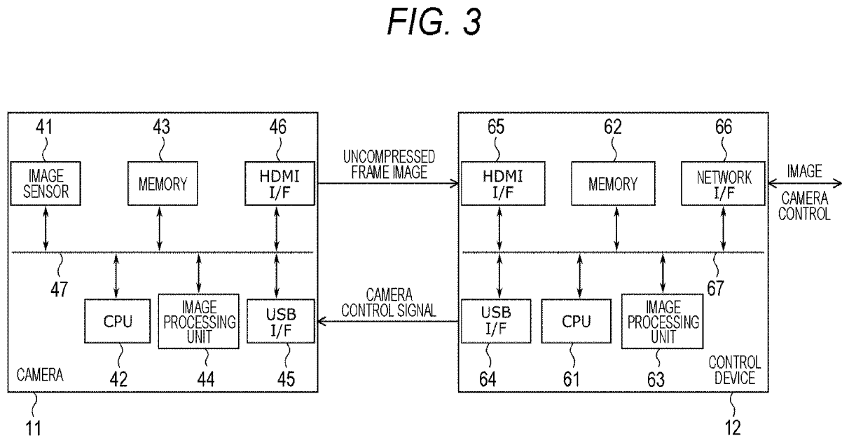

FIG. 3 is a block diagram illustrating a configuration example of a camera 11 and a control device 12.

The camera 11 has an image sensor 41, a central processing unit (CPU) 42, a memory 43, an image processing unit 44, a universal serial bus (USB) I/F 45, and a High-Definition Multimedia Interface (HDMI) (registered trademark) I/F 46, or the like. The image sensor 41, the CPU 42, the memory 43, the image processing unit 44, the USB I/F 45, and the HDMI I/F 46 are connected to one another via a bus 47.

The image sensor 41 includes, for example, a charge coupled device (CCD), a complementary metal oxide semiconductor (CMOS) sensor, or the like, and receives light (images light) from a subject, the light (image light) being incident through an unillustrated imaging lens. Via the bus 47, the image sensor 41 provides the memory 43 with an imaging signal obtained by capturing an image of the subject.

The CPU 42 controls operation of the entire camera 11 according to a program stored in an unillustrated read only memory (ROM). The CPU 42 causes the image sensor 41 to capture an image via the USB I/F 45 for example, according to a control signal provided from the control device 12, or causes the image processing unit 44 to perform image processing of an imaging signal stored in the memory 43.

The memory 43 includes, for example, a random access memory (RAM), and temporarily stores data, a parameter, or the like used in various kinds of processing. For example, the memory 43 stores the imaging signal provided from the image sensor 41, or stores the image data processed in the image processing unit 44, or the like.

The image processing unit 44 executes image processing such as demosaic processing by using the imaging signal imaged by the image sensor 41 and stored in the memory 43, and generates a frame image.

The USB I/F 45 has a USB terminal and sends or receives the control signal, data, or the like for controlling the camera 11 to or from the control device 12 connected via a USB cable. An HDMI® I/F 46 has an HDMI® terminal, and sends or receives the control signal, data, or the like for controlling the camera 11 to or from the control device 12 connected via an HDMI® cable. Although usage of the two communication I/Fs, which are the USB I/F 45 and the HDMI® I/F 46, is not particularly limited, for example, a control signal for controlling the camera 11 is input form the control device 12 to the camera 11 via the USB I/F 45, and image data of an uncompressed frame image is transmitted at a high speed from the camera 11 to the control device 12 via the HDMI® I/F 46.

The control device 12 has a CPU 61, a memory 62, an image processing unit 63, a USB I/F 64, an HDMI® I/F 65, a network I/F 66, or the like. The CPU 61, the memory 62, the image processing unit 63, the USB I/F 64, the HDMI® I/F 65, and the network I/F 66 are connected to one another via a bus 67.

The CPU 61 controls operation of the entire control device 12 according to a program stored in an unillustrated ROM. For example, the CPU 61 outputs the control signal for controlling the camera 11 to the control device 12 via the USB I/F 45 according to a control signal of the camera 11 from the integrated editorial apparatus 13. Furthermore, the CPU 61 stores in the memory 62 an uncompressed frame image transmitted at a high speed from the camera 11 via the HDMI® I/F 65, or causes the image processing unit 63 to perform image processing of an uncompressed frame image stored in the memory 62.

A memory 62 includes, for example, a RAM, and temporarily stores data, a parameter, or the like used in various kinds of processing. The memory 62 has a storage capacity for storing a predetermined number of uncompressed frame images provided from the camera 11, images obtained by performing image processing on the uncompressed frame images in the image processing unit 63.

The image processing unit 63 executes, for example, image processing, such as resolution conversion processing, compression processing, or frame rate conversion processing for converting a frame rate, on an uncompressed frame image stored in the memory 62.

The USB I/F 64 has a USB terminal and sends or receives a control signal, data, or the like for controlling the camera 11 to or from the camera 11 connected via a USB cable. An HDMI® I/F 65 has an HDMI® terminal, and sends or receives a control signal, data, or the like for controlling the camera 11 to or from the camera 11 connected via an HDMI® cable. In the present embodiment, as described above, for example, a control signal for controlling the camera 11 is output from the USB I/F 64 to the camera 11, and image data of an uncompressed frame image is input from the camera 11 to the HDMI® I/F 65.

The network I/F 66 is, for example, a communication I/F that communicates via a network 22 compliant with Ethernet (registered trademark). The network I/F 66 communicates with the integrated editorial apparatus 13 via the network 22. For example, the network I/F 66 acquires the control signal of the camera 11 provided from the integrated editorial apparatus 13 and provides the control signal to the CPU 61, or sends the image data of the uncompressed frame image to the integrated editorial apparatus 13.

Although the camera 11 and the control device 12 are configured to send or receive a control signal, data, or the like by using two communication means, which are a USB I/F and an HDMI® I/F as described above, the camera 11 and the control device 12 may be configured to send or receive a control signal, data, or the like by using only one communication means. Furthermore, a communication method of the communication means is not limited to USB I/F and HDMI® I/F, and another communication method may be used. Moreover, not only wired communication but also wireless communication such as Wi-fi or Bluetooth (registered trademark) may be used. For communication between a control device 12 and the integrated editorial apparatus 13, either wired communication or wireless communication may be used, without regard to a type of communication means.

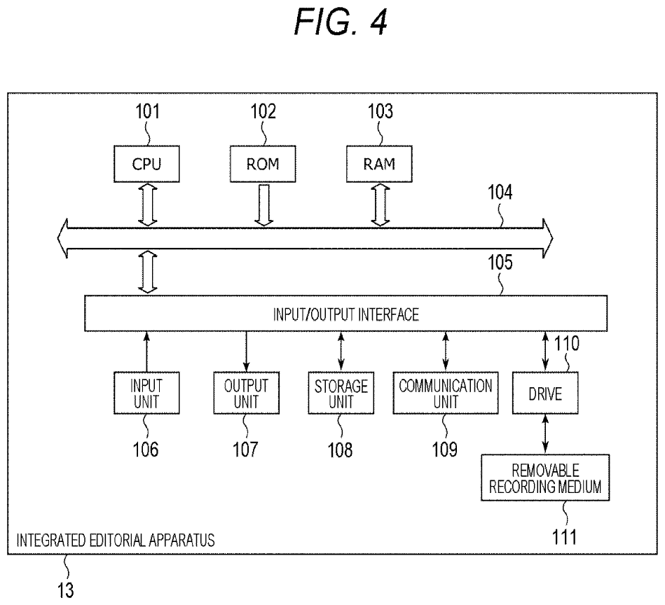

FIG. 4 is a block diagram illustrating a configuration example of hardware of a computer as the integrated editorial apparatus 13.

In the integrated editorial apparatus 13, the CPU 101, the ROM 102, and the RAM 103 are connected to one another by a bus 104.

Moreover, an input/output interface 105 is connected to the bus 104. An input unit 106, an output unit 107, a storage unit 108, a communication unit 109, and a drive 110 are connected to the input/output interface 105.

The input unit 106 includes a keyboard, a mouse, a microphone, a touch panel, an input terminal, or the like. The input unit 106 functions as a reception unit that receives operation by the user, such as selection or an instruction by the user. The output unit 107 includes a display, a speaker, an output terminal, or the like. The storage unit 108 includes a hard disk, a RAM disk, a non-volatile memory, or the like. The communication unit 109 includes a network I/F, or the like. The drive 110 drives a removable recording medium 111 such as a magnetic disk, an optical disk, a magneto-optical disk, or a semiconductor memory.

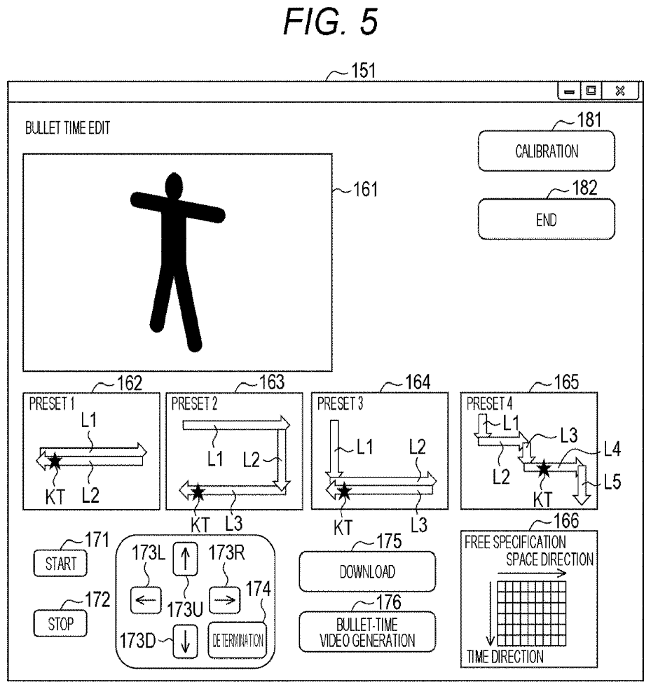

In the integrated editorial apparatus 13 configured as described above, the bullet-time video generation application is stored in, for example, the storage unit 108. The CPU 101 loads the bullet-time video generation application stored in the storage unit 108 into the RAM 103 via the input/output interface 105 and the bus 104 and executes the application, by which the user can shoot and edit the bullet-time video. For example, the CPU 101 displays a bullet-time edit screen in FIG. 5 on the display device 14, or performs processing for encoding a plurality of frame images downloaded from each of the control devices 12 and for generation of the bullet-time video. In a case where images downloaded from the respective control devices 12 are compressed and encoded, the CPU 101 can also perform decompression processing of the compressed images. The CPU 101 that executes the bullet-time video generation application corresponds to a control unit that controls shooting and editing of the bullet-time video. As appropriate, the RAM 103 also stores data necessary for the CPU 101 to execute various kinds of processing.

A program, which includes the bullet-time video generation application, executed by the CPU 101 can be provided by being recorded on the removable recording medium 111 as a package medium, or the like, for example. Furthermore, the program can be provided via a wired or wireless transmission medium such as a local area network, the Internet, or digital satellite broadcasting.

The program can be installed on the storage unit 108 via the input/output interface 105 by attaching the removable recording medium 111 to the drive 110. Furthermore, the program can be received by the communication unit 109 via the wired or wireless transmission medium and installed on the storage unit 108. In addition, the program can be installed on the ROM 102 or the storage unit 108 in advance.

### 4. SCREEN EXAMPLE

FIG. 5 illustrates a screen example of a bullet-time edit screen displayed on the display device 14 by the bullet-time video generation application being executed in the integrated editorial apparatus 13.

A bullet-time edit screen 151 is provided with, along with a title of “bullet time edit”, an image display section 161 for displaying an image captured by the camera 11. While each of the cameras 11 is capturing images for the bullet-time video (in a “live view” state described later), the image display section 161 displays a live view image that is a related image of a frame image captured by a predetermined one camera 11 (hereinafter, also referred to as a representative camera 11). The live view image is, for example, an image having a lower resolution than a frame image buffered in the control device 12.

Furthermore, when frame images to be used for generating the bullet-time video are selected (in a “frame selection” state described later), the image display section 161 displays a stop image that is an image (still image) for preview for frame selection. The stop image is also, for example, an image having a lower resolution than a frame image buffered in the control device 12, and is a related image of the frame image.

With a live view image or stop image having a lower resolution than a frame image, it is possible to save a network band and to achieve high-speed transmission and high-speed display during imaging or frame selection. Note that, in a case where processing capacity of the integrated editorial apparatus 13 is large and there is spare network band, a frame image buffered in the control device 12 may be transmitted as is to the integrated editorial apparatus 13 to be displayed as a live view image or stop image, needless to say.

Below the image display section 161 of the bullet-time edit screen 151, there are displayed frame selection mode buttons 162 to 166 corresponding to a plurality of frame selection modes.

The frame selection mode buttons 162 to 166 are buttons for specifying a method for selecting frame images to be used for the bullet-time video on the basis of arrangement of frame images captured by each of the cameras 11, the frame images being arranged in the two-dimensional space that includes the space direction of each of the cameras 11 as the horizontal axis and the time direction in accordance with an imaging time of the frame images as a vertical axis. Hereinafter, a space in which a plurality of frame images captured by each of the cameras 11 is arranged in a two-dimensional space is also referred to as a frame arrangement two-dimensional space. The two-dimensional space includes the space direction of each of the cameras 11 as the horizontal axis, and the time direction in accordance with an imaging time of the frame images as a vertical axis.

The frame selection mode buttons 162 to 165 are buttons for frame selection modes in which methods for selecting frame images to be used for the bullet-time video are predetermined (preset) with a key timing KT as a base point.

In frame selection modes of the frame selection mode buttons 162 to 165, by the user specifying the key timing KT, predetermined frame images among a plurality of frame images arranged in the frame arrangement two-dimensional space are (automatically) selected as frame images to be used for the bullet-time video with the key timing KT as a base point. Specification of the key timing KT is operation of identifying, among the frame images arranged in the frame arrangement two-dimensional space, the time direction of frame images to be used for the bullet-time video.

In a frame selection mode (preset 1) executed by the frame selection mode button 162, when the key timing KT is determined, from among a plurality of frame images arranged in the frame arrangement two-dimensional space, each of the frame images in a row L1 and each of the frame images in a row L2 are selected, with the key timing KT as a base point, as frame images to be used for the bullet-time video. The frame images in the row L1, of which imaging time indicated by the vertical axis in the frame arrangement two-dimensional space is the same time as the key timing KT, correspond to respective frame images captured by cameras from a leftmost camera 11A to a rightmost camera 11H. The frame images in the row L2, of which imaging time indicated by the vertical axis in the frame arrangement two-dimensional space is the same time as the key timing KT, correspond to respective frame images captured by cameras from the rightmost camera 11H to the leftmost camera 11A.

In a frame selection mode (preset 2) executed by the frame selection mode button 163, when a key timing KT is determined, from among a plurality of frame images arranged in the frame arrangement two-dimensional space, each of the frame images in the row L1, each of the frame images in a column L2, and each of the frame images in the row L3 are selected, with the key timing KT as a base point, as frame images to be used for the bullet-time video. The frame images in the row L3, of which imaging time indicated by the vertical axis is the same time as the key timing KT, correspond to respective frame images captured by cameras from the rightmost camera 11H to the leftmost camera 11A. The column L2, of which imaging time at an ending point is the same time as the key timing KT, and an imaging time of the rightmost camera 11H corresponds to respective frame images captured during a period from a predetermined time to a time that is the same as the key timing KT. The row L1, of which imaging time is the same as an imaging time at a starting point of the column L2, and corresponds to respective frame images captured by cameras from the leftmost camera 11A to the rightmost camera 11H. Length (the number of frames) of the column L2 can be changed as appropriate by a setting by the user.

Note that an example of selecting a frame image illustrated in FIG. 2 corresponds to a frame selection mode executed by the frame selection mode button 163.

In a frame selection mode (preset 3) executed by the frame selection mode button 164, when the key timing KT is determined, from among a plurality of frame images arranged in the frame arrangement two-dimensional space, each of the frame images in a column L1, each of the frame images in the row L2, and each of the frame images in the row L3 are selected, with the key timing KT as a base point, as frame images to be used for the bullet-time video. The frame images in the row L3, of which imaging time indicated by the vertical axis is the same time as the key timing KT, correspond to respective frame images captured by cameras from the rightmost camera 11H to the leftmost camera 11A. The frame images in the row L2, of which imaging time indicated by the vertical axis is the same time as the key timing KT, correspond to respective frame images captured by cameras from the leftmost camera 11A to the rightmost camera 11H. The frame images in the column L1, of which imaging time at an ending point is the same time as the key timing KT, and an imaging time of the leftmost camera 11A corresponds to respective frame images captured during a period from a predetermined time to a time that is the same as the key timing KT. Length (the number of frames) of the column L1 can be changed as appropriate by a setting by the user.

In a frame selection mode (preset 4) executed by the frame selection mode button 165, when the key timing KT is determined, from among a plurality of frame images arranged in the frame arrangement two-dimensional space, each of the frame images in the column L1, each of the frame images in a row L2, each of the frame images in a column L3, each of the frame images in a row L4, and each of the frame images in a column L5 are selected, with the key timing KT as a base point, as frame images to be used for the bullet-time video. The frame images in the row L4, of which imaging time indicated by the vertical axis is the same time as the key timing KT, correspond to respective frame images captured by cameras from a predetermined camera 11 to the leftmost camera 11H. The frame images in the column L5 correspond to respective frame images captured by the rightmost camera 11H during an imaging time from the same time as the key timing KT to a last time. The frame images in the column L3 correspond to respective frame images captured by the same camera 11 as a camera that captured a frame image in a starting point of the row L4 during an imaging time from a predetermined time to the same time as the key timing KT. The frame images in the row L2, of which imaging time is the same as an imaging time of a frame image at a starting point of the column L3, correspond to respective frame images captured by the cameras from the rightmost camera 11A to a camera 11 that captured a frame image in a starting point of the column L3. The frame images in the column L1 correspond to respective frame images captured by the rightmost camera 11A during an imaging time from a start point to the same time as the starting point of row L2. Lengths (the number of frames) of the column L1, row L2, column L3, row L4, and column L5 can be changed as appropriate by a setting by the user.

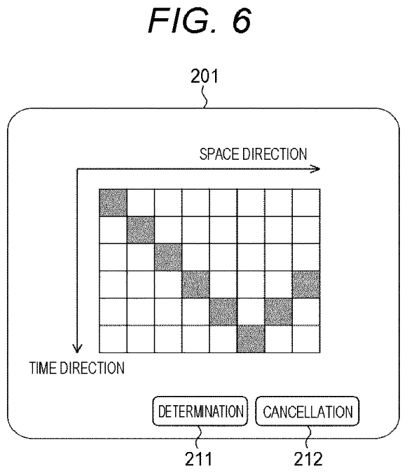

The frame selection mode button 166 is a frame selection mode button that allows a user to freely specify frame images to be used for the bullet-time video. When the frame selection mode button 166 is selected (pressed), a frame selection screen 201 in FIG. 6 is displayed. With the frame selection screen 201, the user can select the frame images to be used for the bullet-time video by selecting, with a click or touch operation, desired areas, among rectangular areas corresponding to respective frame images arranged in the frame arrangement two-dimensional space. For example, an order in which the rectangular areas corresponding to the respective frame images are selected is an order in which the frame images are displayed in the bullet-time video. In FIG. 6, the areas selected for the frame images used for the bullet-time video is colored in gray. A determination button 211 confirms selection of frame images and allows the screen to return to the bullet-time edit screen 151 in FIG. 5. A cancellation button 212 cancels selection of frame images and allows the screen to return to the bullet-time edit screen 151 in FIG. 5.

The bullet-time edit screen 151 in FIG. 5 is further provided with a start button 171, a stop button 172, up, down, right, left direction keys 173, a determination button 174, a download button 175, and a bullet-time video generation button 176.

The start button 171 is operated (pressed) when capturing an image for the bullet-time video. The stop button 172 is operated (pressed) when stopping (ending) an imaging capturing for the bullet-time video. The stop button 172 also corresponds to a space key on the keyboard, and stop of imaging can be specified similarly by pressing the space key.

The up, down, right, left direction keys 173 are buttons operated when changing a live view image or stop image displayed in the image display section 161. The direction keys 173 include an up direction key 173U, a down direction key 173D, a right direction key 173R, and a left direction key 173L. The up, down, right, left directions correspond to respective directions in the frame arrangement two-dimensional space. Therefore, it is possible to switch a live view image displayed in the image display section 161 in the time direction with the up direction key 173U and the down direction key 173D, and in the space direction with the right direction key 173R and the left direction key 173L.

For example, when the up direction key 173U is pressed, a live view image of a frame image, which is captured immediately before a currently displayed live view image in the image display section 161 (hereinafter referred to as a current live view image) by the same camera 11 as the current live view image is displayed in the image display section 161 (display in the image display section 161 is updated).

When the down direction key 173D is pressed, a live view image of a frame image, which is captured immediately after the currently displayed current live view image by the same camera 11 as the current live view image is displayed in the image display section 161.

When the right direction key 173R is pressed, a live view image of a frame image captured by a camera 11 immediately right to a camera 11 by which the current live view image is captured at the same time as the current live view image is displayed in the image display section 161.

When the left direction key 173L is pressed, a live view image of a frame image captured by a camera 11 immediately left to a camera 11 by which the current live view image is captured at the same time as the current live view image is displayed in the image display section 161.

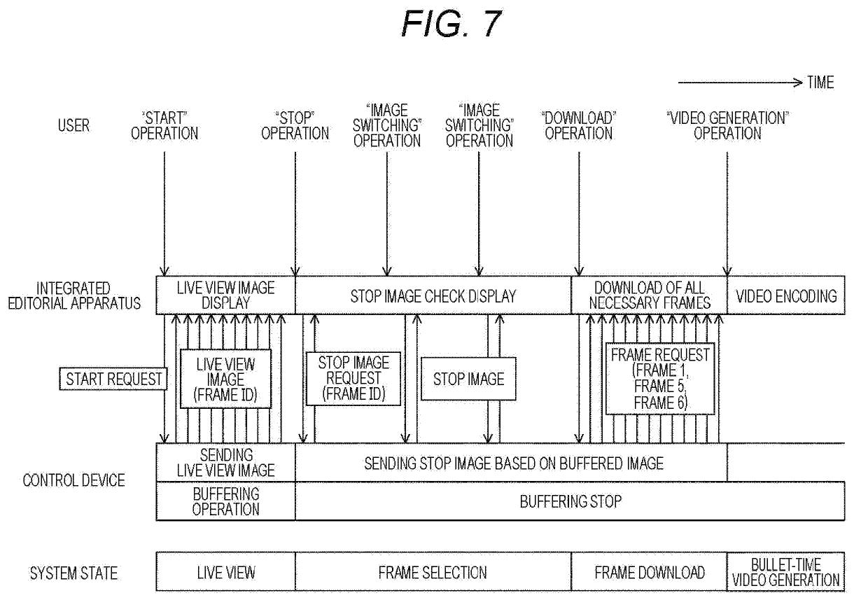

Note that switching in the time direction cannot be performed by using the up direction key 173U and down direction key 173D in the “live view” state described later in FIG. 7, and only switching between the cameras 11 can be performed by using the right direction key 173R and the left direction key 173L. In the “frame selection” state described later, switching (between the cameras 11) in both the time direction and the space direction can be performed. The up direction key 173U, the down direction key 173D, the right direction key 173R, and the left direction key 173L also correspond to direction keys of the keyboard, and specification can be performed similarly by pressing a direction key on the keyboard.

The determination button 174 is operated when setting the key timing KT. When the determination button 174 is operated, an imaging time corresponding to an image (stop image) displayed in the image display section 161 is set as the key timing KT. The determination button 174 also corresponds to an Enter key on the keyboard, and the key timing KT can be specified performed similarly by pressing the Enter key.

Because the key timing KT identifies a timing in the time direction of frame images used for the bullet-time video, the space direction of the cameras 11 on the horizontal axis does not affect determination of the key timing KT. For example, although a star mark indicating the key timing KT is displayed near a left end of the row L1 in the frame selection mode button 162 for the preset 1, any position in the horizontal direction on the vertical axis may be specified for the row L1, because only the time direction on the vertical axis is identified. Therefore, it is not necessary to set the key timing KT in a state where the image (stop image) captured by the camera 11 corresponding to the star mark in the row L1 is displayed, and the key timing KT may be specified in a state where any of the images captured by the plurality of cameras 11A to 11H in the row L2 is displayed.

Note that, although specification of the key timing KT involves identifying a timing in the time direction on the vertical axis in the frame arrangement two-dimensional space in the present embodiment, a timing in the space direction of the cameras 11 on the horizontal axis in the frame arrangement two-dimensional space may be identified. Furthermore, although one key timing KT is specified in the present embodiment, a plurality of key timings KT may be specified. A configuration may be employed in which a method for specifying the key timing KT (specification of the time direction or specification of the space direction, or the number of key timings KT to be specified) can be set by using a setting screen as appropriate.

The download button 175 is a button operated when downloading (acquiring) frame images to be used for the bullet-time video from each of the control devices 12. The download button 175 can be operated (pressed), for example, when the frame selection mode and the key timing KT are determined and the frame images to be used for the bullet-time video are confirmed.

The bullet-time video generation button 176 is a button operated when executing processing for encoding the plurality of downloaded frame images and generating the bullet-time video. The bullet-time video generation button 176 can be operated (pressed) when download of the plurality of frame images to be used for the bullet time video is completed.

A calibration button 181 and an end button 182 are arranged on an upper right of the bullet-time edit screen 151.

The calibration button 181 is a button operated when executing calibration processing for setting mutual positional relations among the plurality of cameras 11. To calculate positions and orientations of the plurality of cameras 11, for example, it is possible to use a technique referred to as Structure from Motion, by which a three-dimensional shape of a subject, and a position and orientation of a cameras 11 are simultaneously restored from frame images captured from a plurality of viewpoint positions.

The end button 182 is a button operated when ending the bullet-time video generation application.

### 5. A SERIES OF FLOW OF BULLET-TIME VIDEO Generation

Next, with reference to FIG. 7, a series of flow of bullet-time video generation by the shooting system 1 will be described.

FIG. 7 illustrates operation by the user, corresponding processing by a control device 12 and by the integrated editorial apparatus 13, and a system state of the shooting system 1.

In a case where starting bullet-time video generation, first, the user operates the start button 171 on the bullet-time edit screen 151 (“start” operation).

When the integrated editorial apparatus 13 receives pressing of the start button 171 by the user, the system state of the shooting system 1 transitions to the “live view” state. The “live view” state continues until the user operates the stop button 172 on the bullet-time edit screen 151.

In the “live view” state, in response to operation of the start button 171, a start request that requests start of imaging by the cameras 11 and buffering to the control devices 12 is sent from the integrated editorial apparatus 13 to each of the control device 12.

Each of the control devices 12 receives the start request, provides a control signal for starting imaging to the connected camera 11, and causes the camera 11 to start imaging the subject. Furthermore, each of the control devices 12 acquires and buffers (stores) frame images sequentially provided from the camera 11. When the frame images sequentially provided from the camera 11 are buffered in the memory 62, each of the control devices 12 assigns a frame ID for identification to each of the frame images and stores the frame images. The frame ID may be, for example, a time code based on a synchronization signal between the cameras 11, or the like. In this case, the same time code is assigned as a frame ID to the frame images captured at the same time by each of the synchronized cameras 11.

Of the plurality of control devices 12 constituting the shooting system 1, a control device 12 connected to the representative camera 11 (hereinafter, referred to as a representative control device 12) provides live view images, which are generated from buffered frame images subjected to resolution conversion processing for lowering resolution, to the integrated editorial apparatus 13 via a predetermined network 22, along with frame IDs of the live view images. The live view images may be generated by performing compression processing in addition to the resolution conversion processing.

The integrated editorial apparatus 13 displays in the image display section 161 the live view images sequentially sent from the representative control device 12. The user can switch the representative camera 11 by pressing the right direction key 173R or the left direction key 173L. A viewpoint of a live view image displayed in the image display section 161 of the bullet-time edit screen 151 is changed in response to switching of the representative camera 11. The representative camera 11 as an initial value can be set in advance on the setting screen, for example.

The user monitors the live view image displayed in the image display section 161 and presses the stop button 172 on the bullet-time edit screen 151 at a predetermined timing (“stop” operation).

When pressing of the stop button 172 is detected, the system state of the shooting system 1 transitions from the current “live view” state to the “frame selection” state. In the “frame selection” state, the integrated editorial apparatus 13 switches the live view image to be displayed in the image display section 161 in response to operation of a direction key 173 by the user.

First, when receiving pressing of the stop button 172, the integrated editorial apparatus 13 sends, to each of the control devices 12, a stop image request that requests a stop image, along with a frame ID received immediately after the stop button 172 is pressed. A stop image is a preview image (still image) to be displayed in the image display section 161 for frame selection after the system state of the shooting system 1 shifts from the current “live view” state to the “frame selection” state. The stop image is also a related image of a frame image, and can be obtained by lowering resolution of a frame image or performing image processing such as compression processing.

Each of the control devices 12 that has received the stop image request provides a control signal for stopping imaging to the connected camera 11, and causes the camera 11 to stop imaging the subject.

Furthermore, in each of the control devices 12, in a case where a frame image of which frame ID shows later time than a frame ID received along with the stop image request is buffered in the memory 62 due to a time lag or the like, the buffered frame image is deleted. With this arrangement, the same number of frame images captured at the same time are stored in a memory 62 of each of the plurality of control devices 12.

Moreover, the representative control device 12 connected to the representative camera 11 sends a stop image corresponding to the received frame ID to the integrated editorial apparatus 13 in response to the stop image request. The integrated editorial apparatus 13 displays the received stop image in the image display section 161. Therefore, all the control devices 12 that have received the stop image request execute processing for stopping buffering, and, moreover, only the representative control device 12 performs processing of sending a stop image to the integrated editorial apparatus 13 in response to the stop image request.

In the “frame selection” state, the integrated editorial apparatus 13 switches the stop image displayed in the image display section 161 in response to operation of a direction key 173 by the user. A stop image can be switched in the time direction with the up direction key 173U and the down direction key 173D, and the stop image can be switched in the space direction (switching of the representative camera 11) with the right direction key 173R and the left direction key 173L.

In response to the user pressing a direction key 173, the stop image request and a frame ID are sent from the integrated editorial apparatus 13 to the representative control device 12. The representative control device 12 that has received the stop image request and the frame ID generates a stop image corresponding to the received frame ID and sends the stop image to the integrated editorial apparatus 13. The integrated editorial apparatus 13 displays the received stop image in the image display section 161.

As a reference for selection of a frame image to be downloaded and determination of the key timing KT, the user checks the stop image updated and displayed in the image display section 161 in response to pressing of a direction key 173. In response to operation of a direction key 173 by the user, sending of the stop image request and a frame ID, and display of a stop image are repeatedly executed an arbitrary number of times. The stop image request and the frame ID are stored in an Ethernet (registered trademark) frame with an MAC address of the representative control device 12 as a destination MAC address, for example, and are transmitted via the network 22.

In the “frame selection” state, stop images transmitted between the representative control device 12 and the integrated editorial apparatus 13 may be stop images obtained by lowering resolution of or performing compression processing on buffered frame images, by which a network band can be saved.

When the user determines a frame selection mode with the frame selection mode buttons 162 to 165 and determines the key timing KT with the determination button 174, the frame images to be used for the bullet-time video are confirmed. Alternatively, when the frame selection mode button 166 is pressed, and desired areas, among rectangular areas corresponding to respective frame images arranged in the frame arrangement two-dimensional space are selected, the frame images to be used for the bullet-time video are confirmed.

When the download button 175 is pressed (“download” operation) after the frame images to be used for the bullet-time video are confirmed, the system state of the shooting system 1 transitions from the “frame selection” state to the “frame download” state. The “frame download” state continues until the user presses the bullet-time video generation button 176 on the bullet-time edit screen 151.

In the “frame download” state, a frame request that requests a plurality of frame images determined to be used for the bullet-time video is sent, along with frame IDs, from the integrated editorial apparatus 13 to a control device 12 in which frame images are buffered. In a case of requesting a plurality of frame images from one control device 12, the integrated editorial apparatus 13 can send the frame request by adding a plurality of frame IDs. For example, it is possible to send frame IDs=1, 5, 6 and a frame request to the control device 12A, send a frame ID=1 and a frame request to the control device 12B, and send frame IDs=1, 2, 3, 4 and a frame request to the control device 12C. Destination of a frame request is specified, for example, by a destination MAC address in an Ethernet (registered trademark) frame.

When download (acquisition) of all the frame images to be used for the bullet-time video is completed, the bullet-time video generation button 176 can be pressed.

Then, when the user presses the bullet-time video generation button 176 (“video generation” operation), a system state of the shooting system 1 transitions from the current “frame download” state to the “bullet-time video generation” state.

In the “bullet-time video generation” state, the integrated editorial apparatus 13 generates the bullet-time video by arranging all downloaded frame images in a predetermined order and performing encoding processing. The generated bullet-time video is stored in the storage unit 108.

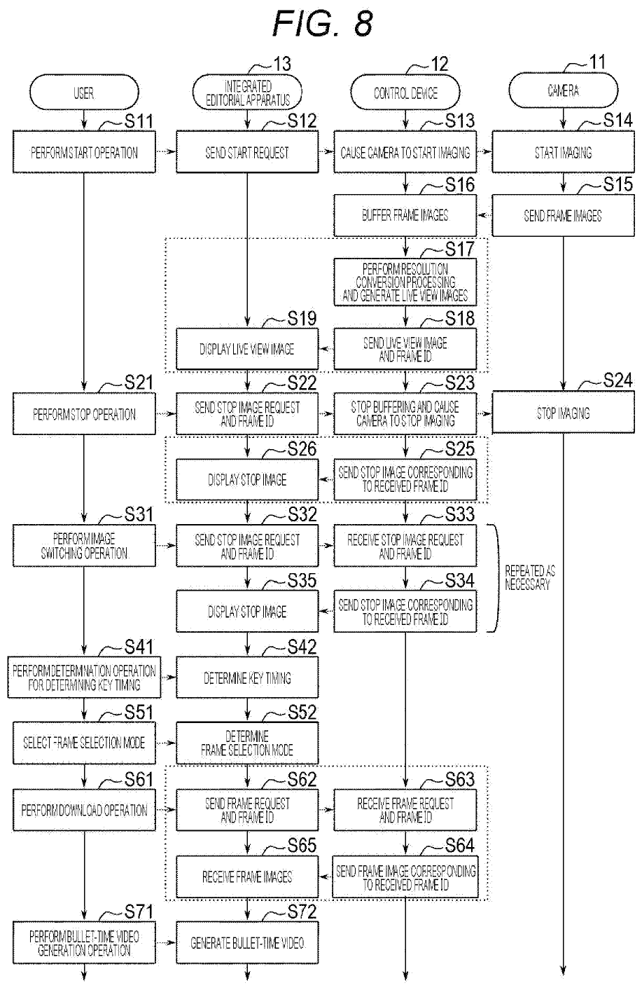

Processing of a bullet-time video generation by the shooting system 1 will be described in more detail with reference to a flowchart in FIG. 8.

First, in Step S11, the user performs start operation of imaging. That is, the user presses the start button 171 on the bullet-time edit screen 151.

In Step S12, (the bullet-time video generation application of) the integrated editorial apparatus 13 receives pressing of the start button 171 by the user, and sends a start request that requests start of imaging by the cameras 11 and buffering to the control devices 12 to each of the control device 12.

In Step S13, each of the control devices 12 receives the start request, provides the connected camera 11 with a control signal for starting imaging, and causes the camera 11 to start imaging the subject. Each of the cameras 11 starts imaging in Step S14, and sends frame images obtained by the imaging to the control device 12 in Step S15. In Step S16, the control device 12 acquires and buffers (stores) the frame images provided from the camera 11. Processing in Steps S14 to S16 are repeatedly executed between each of the cameras 11 and corresponding control devices 12 until a control signal for stopping imaging is sent from the control device 12 to the camera (processing in Step S23 described later).

Furthermore, in the representative control device 12 connected to the representative camera 11 to be displayed in the image display section 161, following the processing in Step S16, processing in next Steps S17 and S18 are also executed. In Step S17, the representative control device 12 performs resolution conversion processing for lowering resolution on the buffered frame images and generates live view images. Then, in Step S18, the representative control device 12 sends a generated live view image and frame ID thereof to the integrated editorial apparatus 13 via the predetermined network 22. In Step S19, the integrated editorial apparatus 13 displays in the image display section 161 a live view image sent from the representative control device 12. The processing in Steps S17 to S19 is executed every time a frame image is buffered in the memory 62 in the representative control device 12. In processing in Steps S17 to S19, the representative control device 12 and the representative camera 11 connected to the representative control device 12 may be changed by operating the right direction key 173R or the left direction key 173L.

In Step S21, the user performs stop operation of imaging. That is, the user presses the stop button 172 on the bullet-time edit screen 151 or presses the space key.

In Step S22, (the bullet-time video generation application of) the integrated editorial apparatus 13 receives pressing of the start button 171 by the user, and sends, to each of the control devices 12, a stop image request that requests a stop image and a frame ID received immediately after the stop button 172 is pressed.

In Step S23, each of the control devices 12 receives the stop image request, stops buffering, provides with the connected camera 11 a control signal for stopping imaging, and causes the camera 11 to stop imaging the subject. Furthermore, in Step S23, in a case where a frame image of which frame ID shows later time than a frame ID received along with the stop image request is buffered in the memory 62, each of the control devices 12 deletes the buffered frame image. In Step S24, the cameras 11 stop imaging the subject.

Moreover, the representative control device 12 also performs processing in Step S25. In Step S25, the representative control device 12 sends a stop image corresponding to the received frame ID to the integrated editorial apparatus 13, and in Step S26, the integrated editorial apparatus 13 displays in the image display section 161 the stop image received from the representative control device 12.

In Step S31, the user performs image switching operation. That is, the user presses any of the up, down, left, or right direction key 173.

In Step S32, the integrated editorial apparatus 13 receives pressing of a direction key 173 by the user and sends a stop image request and a frame ID to the representative control device 12 having (a frame image corresponding to) a stop image to be displayed. The representative control device 12 receives the stop image request and the frame ID in Step S33, and generates a stop image corresponding to the received frame ID and sends the stop image to the integrated editorial apparatus 13 in Step S34. In Step S35, the integrated editorial apparatus 13 receives the stop image from the representative control device 12 and displays the stop image in the image display section 161.

A series of processing in Steps S31 to S35 is repeatedly executed every time the user presses any of the up, down, left, or right direction key 173.

In Step S41, the user performs determination operation for determining the key timing KT. That is, the user presses the determination button 174 on the bullet-time edit screen 151 or presses the Enter key.

In Step S42, the integrated editorial apparatus 13 receives the pressing of the determination button 174 or Enter key by the user, and determines the key timing KT, that is, a timing to be a base point in the time direction of the frame images to be used for the bullet-time video.

In Step S51, the user selects a frame selection mode. That is, the user presses any of the frame selection mode buttons 162 to 166 on the bullet-time edit screen 151.

In Step S52, the integrated editorial apparatus 13 receives pressing of any of the frame selection mode buttons 162 to 166 and determines a frame selection mode.

Either determination of the key timing KT in Steps S41 and S42 or determination of the frame selection mode in Steps S51 and S52 may be performed first. Furthermore, in a case where the frame selection mode button 166 is selected, and desired areas, among rectangular areas corresponding to respective frame images, are selected, determination of the key timing KT in Steps S41 and S42 is omitted. When the frame images to be used for the bullet-time video are confirmed by using any of the frame selection mode buttons 162 to 166, the download button 175 is displayed so as to be pressed.

In Step S61, the user performs download operation. That is, the user presses the download button 175 on the bullet-time edit screen 151.

In Step S62, the integrated editorial apparatus 13 sends a frame request that requests a frame image and frame ID to a control device 12 in which frame images to be used for the bullet-time video are buffered. A plurality of frame IDs can be specified. The control device 12 receives the frame request and frame ID from the integrated editorial apparatus 13 in Step S63, and sends a frame image corresponding to the received frame ID to the integrated editorial apparatus 13 in Step S64. In Step S65, the integrated editorial apparatus 13 receives the frame images sent from the control devices 12 and causes the storage unit 108 to store the frame images.

Processing in Steps S62 to S65 is executed in parallel between the integrated editorial apparatus 13 and all the control devices 12 in which frame images to be used for the bullet-time video are buffered. When download of all the frame images to be used for the bullet-time video is completed, the bullet-time video generation button 176 can be pressed.

In Step S71, the user performs bullet-time video generation operation. That is, the user presses the bullet-time video generation button 176 on the bullet-time edit screen 151.

In Step S72, the integrated editorial apparatus 13 receives pressing of the bullet-time video generation button 176 by the user and generates the bullet-time video. Specifically, the integrated editorial apparatus 13 generates the bullet-time video by arranging all downloaded frame images in a predetermined order and performing encoding processing. The generated bullet-time video is stored in the storage unit 108, and the processing of the bullet-time video generation ends.

According to processing of a bullet-time video generation by the shooting system 1, in the “live view” state, frame images obtained by imaging by each of the cameras 11 are transmitted without being compressed to the corresponding control device 12 at a high speed, and are buffered, and a live view image for preview is sent from the representative control device 12 to the integrated editorial apparatus 13 and displayed. Furthermore, in the “frame selection” state also, a stop image for preview selected by using a direction key 173 is sent to the integrated editorial apparatus 13 and displayed. Live view images and stop images transmitted, as related images related to the buffered frame images, between the representative control device 12 and the integrated editorial apparatus 13 may be live view images and stop images obtained by lowering resolution of or performing compression processing on buffered frame images, by which a network band can be saved.

In the “frame selection” state, in a frame selection mode by the frame selection mode buttons 162 to 165, the user determines the key timing KT while checking a stop image displayed in the image display section 161, by which frame images to be sued for the bullet-time video are determined. In a frame selection mode by the frame selection mode button 166, the user selects desired areas, among rectangular areas corresponding to respective frame images arranged in the frame arrangement two-dimensional space, by which frame images to be used for the bullet-time video are determined. With respect to the frame images to be sued for the bullet-time video, the frame selection mode buttons 162 to 166 function as a user selection unit that receives selection of the space direction indicating arrangement of the plurality of cameras 11 and the time direction indicating imaging time of frame images. The selection is made by the user on the basis of a stop image displayed in the image display section 161. When the frame images to be used for the bullet-time video are determined, the user presses the download button 175, by which the integrated editorial apparatus 13 requests (send a frame request to) each of the control devices 12 to perform downloading.

In the “frame selection” state, frame images are managed in an expression form in which the frame images buffered in the each of the control devices 12 are arranged in the two-dimensional space, and a user interface (user I/F) that causes a user to select frame images necessary for the bullet-time video is adopted. In the two-dimensional space, a horizontal axis (X-axis) represents the space direction of the cameras 11 (arrangement direction of the cameras 11), and a vertical axis (Y-axis) represents the time direction in accordance with an imaging time of the frame images. The time direction corresponds to frame IDs of frame images. With this arrangement, frame images necessary for the bullet-time video can be selected intuitively with a small number of steps, by which time for frame selection can be reduced.

Then, only frame images necessary for generation of the bullet-time video are downloaded from each of the control devices 12 to the integrated editorial apparatus 13, by which a network band used for acquisition of the frame images can be reduced, and time for frame image transmission can be reduced. Furthermore, the memory area in the integrated editorial apparatus 13 to be used can be reduced.

In the “live view” state or the “frame selection” state, live view images or stop images displayed in the image display section 161 are transmitted after being subjected to image processing such as resolution conversion processing in advance by the control device 12, by which processing load of the integrated editorial apparatus 13 can be reduced.

Processing by the integrated editorial apparatus 13 is mainly encoding downloaded frame images and generating the bullet-time video, and the integrated editorial apparatus 13 can be implemented by a general computer device such as a smartphone or a personal computer.

### 6. MODIFICATIONS

The shooting system 1 is not limited to the above-described embodiment, and for example, the following modifications are also possible.

### Modification 1

Although the representative control device 12 generates in the “live view” state, live view images from frame images subjected to lowering of resolution and buffered in the memory 62, and send the live view images to the integrated editorial apparatus 13 in the above-described embodiment, the representative control device 12 may also execute frame rate conversion processing for lowering a frame rate. In this case, the representative control device 12 can thin out the buffered frame images at predetermined frame intervals, and send, to the integrated editorial apparatus 13, images obtained by converting resolution of the thinned out frame images as live view images.

Note that, even in a case where a live view image subject to frame thinning is displayed in the image display section 161 in the “live view” state, a stop image updated and displayed in the image display section 161 on the bullet-time edit screen 151 in response to pressing of a direction key 173 in the “frame selection” state mode may be an image not subjected to thinning-out processing but only to resolution conversion.

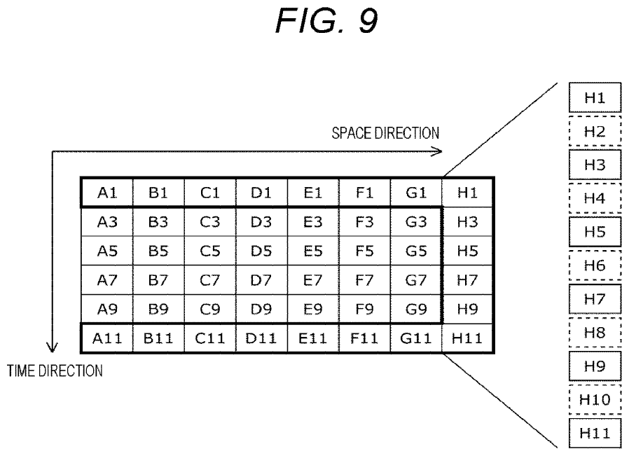

Alternatively, in the “frame selection” state, as in the “live view” state, stop images updated and displayed in the image display section 161 in response to pressing of a direction key 173 may be images subjected to thinning-out processing. In a case where stop images subjected to thinning-out processing are displayed in the image display section 161 and the integrated editorial apparatus 13 requests frame images from the control device 12 in the “frame download” state, frame IDs for frame images that are not displayed due to thinning-out processing are also required to be specified as illustrated in FIG. 9.

FIG. 9 is a diagram describing a request for frame images in the “frame download” state in a case the thinned-out stop images subjected to thinning-out processing are displayed in the image display section 161.

In the example of FIG. 9, stop images thinned out at intervals of one image in the time direction are displayed in the image display section 161. For example, if the down direction key 173D is pressed for switching the time direction in a state where a stop image D1′ of a frame image D1 is displayed in the image display section 161, a stop image D3′, a stop image D5′, and a stop image D7′ are displayed in that order.

Then, assuming that, as in the example in FIG. 2, the frame selection mode of the preset 2 (frame selection mode button 163) is selected, and stop images surrounded by a thick frame are selected as frame images necessary for generation of the bullet-time video, as in illustrated in FIG. 9, the integrated editorial apparatus 13 sends a frame request, to the control device 12H corresponding to the camera 11H, by specifying frame IDs of not only frame images H1, H3, H5, H7, H9, and H11 but also the thinned-out frame images H2, H4, H6, H8, and H10 therebetween.

### Modification 2

In the above-described embodiment, frame images are managed in an expression form in which the frame images buffered in the each of the control devices 12 are arranged in a two-dimensional space in which a horizontal axis (X-axis) represents an arrangement direction (space direction) of the cameras 11, which are arranged in a horizontal direction with respect to the subject 21, and a vertical axis (Y-axis) represents the time direction in accordance with an imaging time of the frame images, the vertical axis being orthogonal to the horizontal axis (X-axis), and the user I/F that causes a user to select frame images necessary for the bullet-time video is used.

Meanwhile, in a bullet-time shooting, there may be a method in which a plurality of cameras 11 is arranged in two dimensions in the horizontal direction and vertical direction (elevation angle direction) with respect to the subject 21 for shooting.

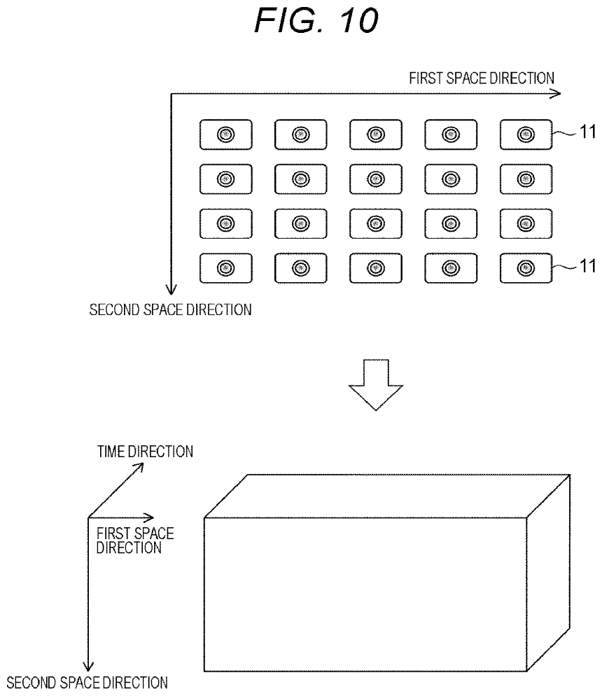

FIG. 10 is a diagram describing a method for managing frame images and the user I/F in a case where a plurality of cameras 11 is arranged in two dimensions for shooting.

In a case where the plurality of cameras 11 is arranged in two dimensions, it is possible to adopt an expression form in which frame images buffered in each of the control devices 12 is arranged in a three-dimensional space. In the three-dimensional space, a horizontal space direction as a first space direction and a vertical space direction (elevation angle direction) as a second space direction are directions orthogonal to each other, and moreover, the time direction in accordance with imaging time is a direction orthogonal to the plurality of space directions (first and second space directions). Specifically, for example, it is possible to implement a user I/F that manages frame images with an expression form in which frame images are arranged in a three-dimensional space, and allows a user to select frame images necessary for the bullet-time video. In the three-dimensional space, a horizontal space direction of the cameras 11 represents a horizontal axis (X-axis), a vertical space direction (elevation angle direction) of the cameras 11 represents a vertical axis (Y-axis), and the time direction in accordance with imaging time of the frame images represents a depth direction (Z-axis).

(The cameras 11 that image) the live view images to be displayed in the image display section 161 on the bullet-time edit screen 151 can be switched as follows, for example. It is possible to switch the cameras 11 in the first space direction by using the right direction key 173R or the left direction key 173L, switch the cameras 11 in the second space direction by using the up direction key 173U or the down direction key 173D, and switch the time direction by, while pressing a shift key, pressing the up direction key 173U or down direction key 173D.

### Modification 3

Although a camera 11 that captures the subject 21 and a control device 12 that buffers the frame image obtained by the imaging are separately configured in the above-described embodiment, the camera 11 and the control device 12 may be configured by one integrated device.

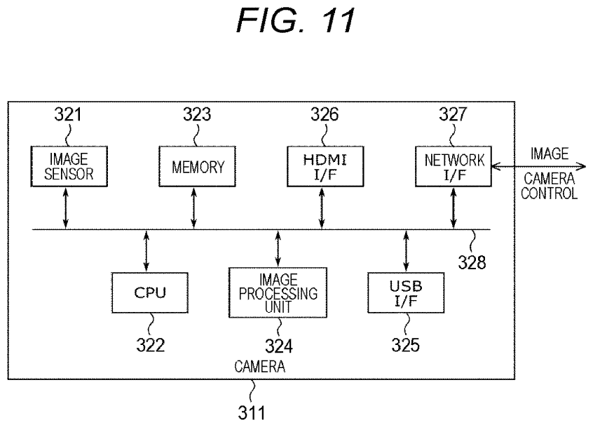

FIG. 11 is a block diagram illustrating a configuration example of a camera in which functions of an above-described camera 11 and control device 12 are integrated.

A camera 311 in FIG. 11 has an image sensor 321, a CPU 322, a memory 323, an image processing unit 324, a USB I/F 325, an HDMI® I/F 326, a network I/F 327, or the like. The image sensor 321, the CPU 322, the memory 323, the image processing unit 324, the USB I/F 325, the HDMI® I/F 326, and the network I/F 327 are connected to one another via a bus 328.

The image sensor 321 includes, for example, a CCD or a CMOS sensor, or the like, and receives light (images light) from a subject, the light (image light) being incident through an unillustrated imaging lens. The image sensor 321 provides an imaging signal obtained by capturing image of the subject to the memory 323 via the bus 328.

The CPU 322 controls operation of an entire camera 311 according to a program stored in an unillustrated ROM. The CPU 322 executes processing similar to processing by the CPU 42 in an above-described camera 11 and by the CPU 61 in an above-described control device 12.

The memory 323 executes processing similar to processing by the memory 43 in an above-described camera 11 and by the memory 62 in an above-described control device 12. Specifically, the memory 323 stores an imaging signal provided from the image sensor 321, a demosaiced uncompressed frame image, or the like.

The image processing unit 324 executes processing similar to processing by the image processing unit 44 in an above-described camera 11 and by the image processing unit 63 in an above-described control device 12.

Specifically, the image processing unit 324 executes image processing such as demosaic processing, resolution conversion processing, compression processing, or frame rate conversion processing, for example.

The USB I/F325 has a USB terminal and sends or receives control signals and data to and from an external device connected via a USB cable. The HDMI® I/F 326 has an HDMI® terminal and sends or receives control signals and data to and from an external device connected via an HDMI® cable.

The network I/F 327 is, for example, a communication I/F that communicates via a network 22 compliant with Ethernet (registered trademark). The network I/F 327 communicates with the integrated editorial apparatus 13 via the network 22. For example, the network I/F 327 acquires a control signal of the camera 11 provided from the integrated editorial apparatus 13 and provides the control signal to the CPU 322, or sends image data of an uncompressed frame image to the integrated editorial apparatus 13.

### Modification 4

Although the bullet-time video is generated by using only a plurality of frame images acquired from a plurality of control devices 12 in the above-described embodiment, frame images in a virtual viewpoint may be generated from a plurality of frame images acquired from the plurality of control devices 12, and the bullet-time video may be stopped along with the generated frame images in the virtual viewpoint (virtual viewpoint frame images), for example.

For example, (the bullet-time video generation application executed on) the CPU 101 on the integrated editorial apparatus 13 performs image frame interpolation processing by using a frame image X1 acquired from a control device 12X (X=A, B, C, . . . , H) and a frame image Y1 acquired from a control device 12Y (Y=A, B, C, . . . , H, X≠Y), by which the CPU 101 generates a frame image Z1 in a predetermined viewpoint (virtual viewpoint) between viewpoints of a camera 11X and camera 11Y. Then, for example, by performing encoding including the frame images X1, Z1, and Y1, it is possible to generate the bullet-time video in which a viewpoint is moved in the space direction in an order of the frame images X1, Z1, and Y1.

Note that a method for generating a frame image in the virtual viewpoint is not particularly limited, and any generation method can be used. For example, as described above, a frame image in the virtual viewpoint may be generated from frame images (two-dimensional images) obtained from an actual camera by using interpolation processing, or a frame image in the virtual viewpoint corresponding to a point between the camera 11X and the camera 11Y may be generated by generating a three-dimensional model from frame images generated from the cameras 11A to 11H to generate a frame image in which the generated three-dimensional model is viewed from an arbitrary viewpoint

Furthermore, although described above is an example of interpolating a virtual viewpoint between physically installed cameras 11, that is, interpolating the space direction of a plurality of acquired frame images, a bullet-time video including a frame image generated by interpolating the time direction may be generated.

Embodiments of the present technology are not limited to the above-described embodiments, and various changes can be made without departing from the scope of the present technology.

For example, all or parts of the plurality of embodiments described above may be used in combination.

For example, the present technology can have a configuration of cloud computing in which one function is shared and processed jointly by a plurality of devices via a network.

Furthermore, each step described in the above-described flowchart can be executed by one device, or can be executed by being shared by a plurality of devices.

Moreover, in a case where a plurality of pieces of processing is included in one step, the plurality of pieces of processing included in the one step can be executed by being shared by a plurality of devices, in addition to being executed by one device.

In the present specification, the steps described in the flowcharts may be executed not only, needless to say, in time series in the described order, but also in parallel or as needed at a timing when a call is made, or the like, even if not processed in time series.

Furthermore, in the present specification, the system means a set of a plurality of components (devices, modules (parts), or the like) without regard to whether or not all the components are in the same housing. Therefore, a plurality of devices housed in separate housings and connected via a network, and one device housing a plurality of modules in one housing are both systems.

Note that the effects described herein are only examples, and the effects of the present technology are not limited to these effects. Effects other than those described in the present specification may also be obtained.

Note that the present technology can have the following configurations.

(1)

An information processing device including

a user selection unit that receives, on the basis of a related image related to a captured image obtained by any of a plurality of imaging devices, selection by a user with respect to a space direction indicating arrangement of the plurality of imaging devices and a time direction indicating imaging time of the captured image, and

a control unit that requests a captured image from a processing device retaining a captured image corresponding to the selection by the user.

(2)

The information processing device according to (1),

in which the control unit performs control so as to display, in a display section, the related image to correspond to the space direction and the time direction, and

the user selection unit receives the selection by the user with respect to the related image displayed in the display section.

(3)

The information processing device according to (2),

in which, when the user performs selection operation, the user selection unit receives the related image displayed in the display section as the related image selected by the user.

(4)

The information processing device according to according to (2) or (3),

in which the control unit performs control so that the related image is displayed in the display section, regarding the space direction and the time direction as different directions.

(5)

The information processing device according to (4),

in which the different directions include orthogonal directions.

(6)

The information processing device according to any one of (1) to (5),

in which the space direction has a plurality of directions.

(7)

The information processing device according to any one of (1) to (6),

in which the time direction includes a direction corresponding to a frame ID.

(8)

The information processing device according to any one of (1) to (7),

in which the user selection unit receives selection of one the related image, and

the control unit requests, from one or more the processing devices retaining a plurality of captured images, the plurality of captured images previously determined by arrangement in the space direction and the time direction with the related image selected by the user as a base point.

(9)

The information processing device according to (8),

in which the control unit identifies a timing in the time direction by using the related image selected by the user, and requests a plurality of captured images from one or more the processing devices retaining the plurality of captured images.

(10)

The information processing device according to (1),

in which the user selection unit receives a plurality of selections by the user with respect to the space direction and the time direction, and

the control unit requests, from one or more the processing devices, a plurality of the captured images corresponding to the plurality of selections by the user.

(11)

The information processing device according to any one of (1) to (10),

in which the related image includes an image of which at least one of resolution or a frame rate of the captured image is changed.

(12)

The information processing device according to any one of (1) to (11),

in which the user selection unit receives selection, by the user, with respect to the related image obtained by performing frame thinning on the captured image, and

the control unit also requests the captured image corresponding to the related image obtained by performing the frame thinning.

(13)

The information processing device according to any one of (1) to (12),

in which the user selection unit receives selection of one the related image,

the control unit requests a plurality of the captured images from one or more the processing devices, corresponding to the related image selected by the user, and

a plurality of the captured images includes images of the same subject.

(14)

The information processing device according to any one of (1) to (13),

in which the control unit further encodes a plurality of the captured images acquired from the processing device in response to a request, and generates a moving image.

(15)

The information processing device according to (14),

in which, among a plurality of the captured images, a first captured image and a second captured image are images having different viewpoints, and

the control unit generates a third captured image at a virtual viewpoint between a viewpoint of the first captured image and a viewpoint of the second captured image, performs encoding including the third captured image, and generates the moving image.

(16)

An information processing method including, by an information processing device,

receiving, on the basis of a related image related to a captured image obtained by any of a plurality of imaging devices, selection by a user with respect to a space direction indicating arrangement of the plurality of imaging devices and a time direction indicating imaging time of the captured image, and

requesting a captured image from a processing device retaining a captured image corresponding to the selection by the user.

(17)

A program for causing a computer to function as

a user selection unit that receives, on the basis of a related image related to a captured image obtained by any of a plurality of imaging devices, selection by a user with respect to a space direction indicating arrangement of the plurality of imaging devices and a time direction indicating imaging time of the captured image, and

a control unit that requests a captured image from a processing device retaining a captured image corresponding to the selection by the user.

(18)

An information processing system including a plurality of first information processing devices provided corresponding to a plurality of imaging devices, and a second information processing device,

in which any one first information processing device among the plurality of first information processing devices
sends, to the second information processing device, a related image related to a captured image obtained in corresponding the imaging device, and
the second information processing device includes
   a user selection unit that receives, on the basis of the related image, selection by a user with respect to a space direction indicating arrangement of the plurality of imaging devices and a time direction indicating imaging time of the captured image, and
   a control unit that requests a captured image from the first information processing device retaining a captured image corresponding to the selection by the user.

(19)

The information processing system according to (18),

in which the one first information processing device generates the related image of which at least one of resolution or a frame rate of the captured image is changed, and sends the related image to the second information processing device.

(20)

The information processing system according to (18),

in which the one first information processing device generates the related image obtained by performing frame thinning on the captured image and sends the related image to the second information processing device, and

the control unit requests also the captured image corresponding to the related image obtained by performing the frame thinning.

### REFERENCE SIGNS LIST

1 Shooting system
11A to 11H Cameras
12A to 12H Control devices
13 integrated editorial apparatus
14 Display device
41 Image sensor
44 Image processing unit
61 CPU
62 Memory
63 Image processing unit
101 CPU
102 ROM
103 RAM
106 Input unit
107 Output unit
108 Storage unit
109 Communication unit
110 Drive
151 Bullet-time edit screen
161 Image display section
162 to 165 Frame selection mode buttons
171 Start button
172 Stop button
173 Direction keys
174 Determination button
175 Download button
176 Bullet-time video generation button
311 Cameras
322 CPU
324 Image processing unit

1. An information processing device comprising:
processing circuitry configured to:
receive, on a basis of a related image related to a captured image obtained by any of a plurality of imaging devices, selection by a user with respect to a space direction indicating arrangement of the plurality of imaging devices and a time direction indicating imaging time of the captured image; and
request the captured image from a particular processing device retaining the captured image corresponding to the selection by the user.

2. The information processing device according to claim 1, wherein the processing circuitry is configured to
perform control so as to display, in a display section, the related image to correspond to the space direction and the time direction, and
receive the selection by the user with respect to the related image displayed in the display section.

3. The information processing device according to claim 2,
wherein, when the user performs selection operation, the processing circuitry is configured to receive the related image displayed in the display section as the related image selected by the user.

4. The information processing device according to claim 2,
wherein the processing circuitry is configured to perform control so that the related image is displayed in the display section, regarding the space direction and the time direction as different directions.

5. The information processing device according to claim 4,
wherein the different directions include orthogonal directions.

6. The information processing device according to claim 1,
wherein the space direction has a plurality of directions.

7. The information processing device according to claim 1,
wherein the time direction includes a direction corresponding to a frame ID.

8. The information processing device according to claim 1,
wherein the processing circuitry is configured to
receive selection of one the related image, and
request, from one or more de-processing devices retaining a plurality of captured images, the plurality of captured images previously determined by arrangement in the space direction and the time direction with the related image selected by the user as a base point.

9. The information processing device according to claim 8,
wherein the processing circuitry is configured to identify a timing in the time direction by using the related image selected by the user, and requests the plurality of captured images from the one or more processing devices retaining the plurality of captured images.

10. The information processing device according to claim 1,
wherein the processing circuitry is configured to
receive a plurality of selections by the user with respect to the space direction and the time direction, and
request, from one or more processing devices, a plurality of captured images corresponding to the plurality of selections by the user.

11. The information processing device according to claim 1,
wherein the related image includes an image of which at least one of resolution or a frame rate of the captured image is changed.

12. The information processing device according to claim 1,
wherein the processing circuitry is configured to
receive selection, by the user, with respect to the related image obtained by performing frame thinning on the captured image, and
request the captured image corresponding to the related image obtained by performing the frame thinning.

13. The information processing device according to claim 1,
wherein the processing circuitry is configured to
receive selection of one the related image, and
request a plurality of captured images from one or more processing devices, corresponding to the related image selected by the user, and
wherein the plurality of captured images includes images of a same subject.

14. The information processing device according to claim 1,
wherein the processing circuitry is further configured to encode a plurality of captured images acquired from the particular processing device in response to a request, and generates a moving image.

15. The information processing device according to claim 14,
wherein, among a plurality of captured images, a first captured image and a second captured image are images having different viewpoints, and
the processing circuitry is configured to generate a third captured image at a virtual viewpoint between a viewpoint of the first captured image and a viewpoint of the second captured image, performs encoding including the third captured image, and generates the moving image.

16. An information processing method comprising, by an information processing device:
receiving, on a basis of a related image related to a captured image obtained by any of a plurality of imaging devices, selection by a user with respect to a space direction indicating arrangement of the plurality of imaging devices and a time direction indicating imaging time of the captured image; and
requesting the captured image from a particular processing device retaining a captured image corresponding to the selection by the user.

17. A non-transitory computer readable storage medium storing a program for causing a computer to function as:
a user selection unit that receives, on a basis of a related image related to a captured image obtained by any of a plurality of imaging devices, selection by a user with respect to a space direction indicating arrangement of the plurality of imaging devices and a time direction indicating imaging time of the captured image; and
a control unit that requests the captured image from a particular processing device retaining a captured image corresponding to the selection by the user.

18. An information processing system comprising a plurality of first information processing devices provided corresponding to a plurality of imaging devices, and a second information processing device,
wherein one first information processing device among the plurality of first information processing devices
sends, to the second information processing device, a related image related to a captured image obtained in corresponding the imaging device, and
the second information processing device includes processing circuitry configured to
receive, on a basis of the related image, selection by a user with respect to a space direction indicating arrangement of the plurality of imaging devices and a time direction indicating imaging time of the captured image, and
request the captured image from the one first information processing device retaining the captured image corresponding to the selection by the user.

19. The information processing system according to claim 18,
wherein the one first information processing device generates the related image of which at least one of resolution or a frame rate of the captured image is changed, and sends the related image to the second information processing device.

20. The information processing system according to claim 18,
wherein the one first information processing device generates the related image obtained by performing frame thinning on the captured image and sends the related image to the second information processing device, and
the processing circuitry is configured to request also the captured image corresponding to the related image obtained by performing the frame thinning.
